(19) United States
(12) Patent Application Publication
(10) Pub. No.: US 2017/0103623 A1
(43) Pub. Date: Apr. 13, 2017

(54) SERVER AND POINT-OF-SALE TERMINAL CONFIGURED FOR HIGHER THROUGHPUT PROCESSING OF RETURNED MERCHANDISE

(71) Applicant: TOSHIBA TEC KABUSHIKI KAISHA, Tokyo (JP)

(72) Inventors: Koichi SUGIYAMA, Izunokuni Shizuoka (JP); Keiichi HASEGAWA, Koto Tokyo (JP); Kuniyoshi YAMADA, Ota Tokyo (JP)

(21) Appl. No.: 15/387,485

(22) Filed: Dec. 21, 2016

Related U.S. Application Data
(62) Division of application No. 14/836,853, filed on Aug. 26, 2015.

(30) Foreign Application Priority Data
Sep. 3, 2014 (JP) 2014-179478

(51) Int. Cl. G07G 1/00; G06Q 20/20; G07G 5/00

(52) U.S. Cl. CPC G07G 1/0072; G07G 5/00; G06Q 20/209

(57) ABSTRACT

A server includes a communication interface through which the server communicates with a mobile computing device of a user, a storage unit storing transaction data of a product purchased by the user, and a control unit. The control unit is configured to control the communication unit to transmit, to the mobile computing device, the transaction data and a link for retrieving a code symbol of the product, and in response to an operation of the link on the mobile computing device, transmit to the mobile computing device image data of the code symbol, such that the code symbol is displayed on a display unit of the mobile computing device.

### CROSS-REFERENCE TO RELATED APPLICATION

This application is a divisional of U.S. patent application Ser. No. 14/836,853, filed Aug. 26, 2015, which is based upon and claims the benefit of priority from Japanese Patent Application No. 2014-179478, filed Sep. 3, 2014, the entire contents of which are incorporated herein by reference.

### FIELD

Exemplary embodiments described herein relate generally to a server and a pointer-of-sale terminal, both of which have been configured for higher throughput processing of returned merchandise.

### BACKGROUND

An electronic receipt system of one type delivers electronic data of a purchase transaction at a store (i.e., an electronic receipt) to a computing device of a consumer, instead of printing a conventional paper receipt that is handed to the customer upon completion of the purchase transaction. To receive the electronic receipt, the customer may need to register with the electronic receipt system and provide his or her customer code during the purchase transaction.

When a purchase transaction is carried out with a Point-of-Sales (POS) terminal in a store and a customer requests the electronic receipt, the electronic receipt is generated by the POS terminal and transmitted from the POS terminal to an electronic receipt management server that centrally manages the electronic receipts generated by a plurality of stores. Then, the electronic receipt management server provides the electronic receipt to the computing device of the customer.

After a purchase transaction has been completed, a customer who purchased a product may return the product to a store and request a refund or an exchange of a product. In such a case, a cashier at the store may need to input a product code of a product into the POS terminal. When a tag or a package that indicates a product code or a code symbol of the product has been removed, it may be difficult for the cashier to input data of the returned product.

### DESCRIPTION OF THE DRAWINGS

FIG. 1 illustrates an entire configuration of an electronic receipt system according to an embodiment.

FIG. 2 is a block diagram of an electronic receipt management server in the electronic receipt system.

FIG. 3 illustrates the configuration of data of a merchandise code table stored in the electronic receipt management server.

FIG. 4 is a block diagram of a Point-of-Sales (POS) terminal in the electronic receipt system.

FIG. 5 is a block diagram of a mobile device in the electronic receipt system.

FIG. 6 is a flowchart illustrating a process to output electronic receipt information carried out by the electronic receipt management server.

FIG. 7 is a flowchart illustrating a process to add an event generation trigger to the electronic receipt information carried out by the electronic receipt management server.

FIGS. 8A and 8B each illustrate a screen of the electronic receipt information including icons.

FIG. 9 is a flowchart illustrating a process to output merchandise code carried out by the electronic receipt management server.

FIG. 10 illustrates a screen configuration of a code symbol displayed on the mobile device.

FIG. 11 is a flowchart illustrating a process to return a product carried out by the POS terminal.

### DETAILED DESCRIPTION

An embodiment provides a server capable of acquiring supplementary information (for example, merchandise codes) using merchandise name included in electronic receipt information.

In general, according to an embodiment, a server includes a communication unit configured to communicate with a mobile computing device of a user, a storage unit storing transaction data of a product purchased by the user, and a control unit. The control unit is configured to control the communication unit to transmit, to the mobile computing device, the transaction data and a link for retrieving a code symbol of the product, and in response to an operation of the link on the mobile computing device, transmit to the mobile computing device image data of the code symbol, such that the code symbol is displayed on a display unit of the mobile computing device.

An electronic receipt system enables a consumer to view electronic receipt information obtained by digitizing transaction content on a user terminal (hereinafter referred to as a mobile device) operated by the consumer, instead of receiving a sheet receipt of the transaction content in a store.

In the electronic receipt system, the consumer needs to complete member registration in advance and acquires a member identification (ID) of the consumer (member). Thus, the consumer can enjoy a service provided by the electronic receipt system using the member ID.

In the electronic receipt system, merchandise transaction with a consumer is executed with a point of sales (POS) terminal located at a store. During the merchandise transaction, a consumer executes settlement using cash or a card and ends a transaction.

The POS terminal reads a member ID on each transaction. Thus, the POS terminal generates electronic receipt information obtained by digitizing information related to the transaction instead of outputting a record of the transaction on a sheet receipt. Then, the POS terminal transmits the electronic receipt information to an electronic receipt management server that manages all of the electronic receipt information. Types of electronic receipt information includes “electronic receipt information” generated at the time of normal transaction, “registration minus receipt information” generated at the time when the received amount is short of the value of the product transacted, “electronic return receipt information” generated at the time of return of a transacted product, and “electronic correction receipt information” generated at the time of correcting the transaction data. The consumer can view the “electronic receipt information” transmitted to the electronic receipt management server by accessing the electronic receipt management server from a mobile device.

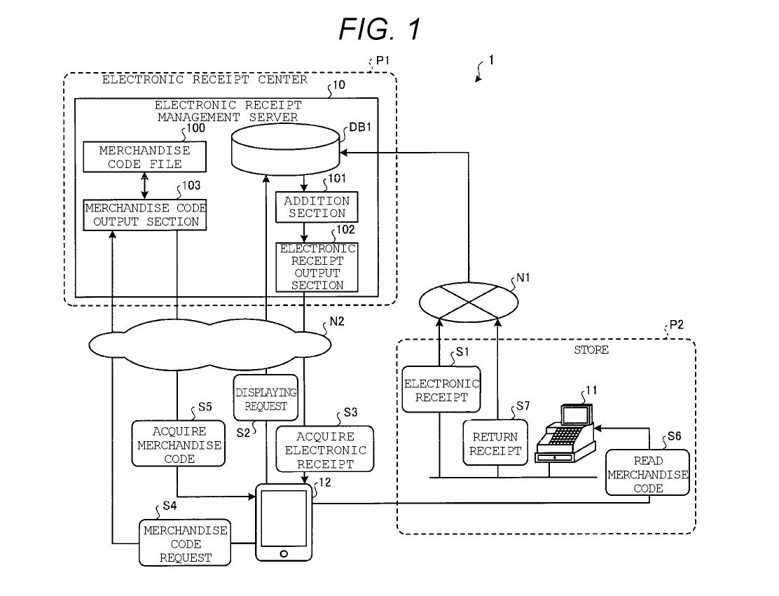

FIG. 1 illustrates the entire configuration of an electronic receipt system according to an embodiment.

As illustrated in FIG. 1, an electronic receipt system 1 includes a network system that includes an electronic receipt management server 10, a POS terminal 11, a mobile device 12. In the present embodiment, the POS terminal 11 accesses the electronic receipt management server 10 on a web via a communication network N1 such as a local area network (LAN) or a virtual private network (VPN). The mobile device 12 accesses the electronic receipt management server 10 on the web over the Internet network (communication network N2). For example, the mobile device 12 accesses the electronic receipt management server 10, for example, by accessing a telephone network via a wireless base station using a packet communication.

Hereinafter, the electronic receipt management server 10 is assumed to include a web server and execute communication with each terminal by Hypertext Transfer Protocol (HTTP).

Solid arrows illustrated in FIG. 1 indicate directions in which main commands or information flow.

The electronic receipt management server 10 is located in an electronic receipt center P1 of a third-party organization. The electronic receipt management server 10 is a server apparatus that consolidates electronic receipt information generated by the POS terminal 11 using a database DB1 (first storage section). The electronic receipt management server 10 receives the electronic receipt information (for example, electronic receipt information (S1)) transmitted by the POS terminal 11 over the communication network N1 and stores the electronic receipt information in the database DB1 to consolidate the electronic receipt information. When the electronic receipt management server 10 receives a request for displaying the electronic receipt information (“displaying request (S2)”) from the mobile device 12, the electronic receipt management server 10 converts the format of the electronic receipt information correlated with the request into a display format of the mobile device 12 that has sent the request. The mobile device 12 displays the electronic receipt information on a display screen of the mobile device 12 (“acquire electronic receipt information (S3)”)

To output merchandise code data, which is supplementary information of a product, to the mobile device 12, the electronic receipt management server 10 includes a merchandise code file 100, an addition section 101, an electronic receipt information output section 102, and a merchandise code output section (supplementary information output section) 103.

The merchandise code file 100 is a data file in which merchandise code data of each product is recorded. The merchandise code file 100 records the merchandise code data and merchandise name data of each product in association therewith. The merchandise code file 100 is stored in a storage unit such as a RAM and serves as a second storage section.

The addition section 101 is a section that correlates a trigger operator (event generation trigger), such as an icon, for acquiring the merchandise code data recorded in the merchandise code file 100 with the electronic receipt information which the mobile device 12 requests to be displayed. For example, the event generation trigger is configured by attaching link information to a process execution destination for acquiring the merchandise code data to an icon image, text information, or the like.

The electronic receipt information output section 102 outputs the electronic receipt information with the event generation trigger attached thereto to the mobile device 12 that has sent the request.

As described above, the electronic receipt management server 10 receives the request for displaying the electronic receipt information (“displaying request (S2)”) from the mobile device 12. The electronic receipt information output section 102 converts the format of the electronic receipt information into a display format of the mobile device that has sent the display request and outputs the electronic receipt information as a response to the mobile device 12. Since the addition section 101 attaches the event generation trigger to the electronic receipt information at any timing for the mobile device 12, the electronic receipt information output section 102 outputs the electronic receipt information to which the event generation trigger is attached to the mobile device 12 of the displaying request source.

Thereafter, the electronic receipt management server 10 receives an operation (an operation of the event generation trigger by, for example, tapping) on the event generation trigger in the electronic receipt information output to the mobile device 12.

The merchandise code output section 103 is a section that extracts the merchandise code data correlated with the merchandise name data included in the electronic receipt information from the merchandise code file 100 in response to the operation of the event generation trigger, and outputs the merchandise code data to the mobile device 12. For example, the merchandise name data included in the electronic receipt information is acquired from the mobile device 12 or the like in response to the operation of the event generation trigger. Then, a process of a link destination indicated by the event generation trigger is executed using the merchandise name data. In this process, the merchandise code data correlated with the merchandise name data acquired from the mobile device 12 or the like is extracted from the merchandise code file 100, and the merchandise code data is output to the mobile device 12.

Thus, when the user operates the event generation trigger on the mobile device 12 (“merchandise code request (S4)”), the mobile device 12 can acquire the merchandise code data managed by the electronic receipt management server 10 mobile device (“acquire merchandise code (S5)”).

The POS terminal 11 is a single POS terminal or a plurality of POS terminals in a store P2. The store P2 may correspond to a single store or a plurality of stores.

The POS terminal 11 includes a barcode scanner to read a merchandise code or a member ID and has a registration function. In the POS terminal 11, a cashier inputs data of transaction target product by reading a merchandise code attached to the product to be purchased by a consumer with the barcode scanner or inputs the merchandise code by operating a merchandise key or numeric keys as input keys. After the merchandise transaction is executed in this way, the consumer makes payment by cash or a card to end the transaction. After the transaction, transaction content is printed on a receipt sheet and a sheet receipt is issued.

The POS terminal 11 includes command keys to which commands to execute various processes are assigned, as input keys. The command keys include a return key, a correction key, a registration minus key, and the like.

For example, the product is assumed to be returned after the transaction. In this case, a cashier inputs a merchandise code of the product to be returned by operating the return key. The POS terminal 11 completes the return process and prints a return receipt including return information on a sheet.

To input the merchandise code of the product to be returned, merchandise code data may be obtained from the mobile device 12, which is acquired from the electronic receipt management server 10 (“read merchandise code (S6)”). Further, various methods such as a method of typing the merchandise code using input key such as numeric keys, a method of pushing down a merchandise key, a method of reading a barcode attached to a merchandise tag with a barcode scanner can be used together.

The POS terminal 11 reads a member ID on each transaction when the consumer is a member. To read the member ID, for example, a barcode scanner may read the member ID displayed as barcode information on the display screen of the mobile device 12. Further, the member ID stored in the mobile device 12 may be transmitted using a communication technique such as short-range wireless communication.

In a normal transaction, the POS terminal 11 generates electronic receipt information obtained by digitizing transaction content corresponding to a transaction after reading the member ID and transmits the electronic receipt information to the electronic receipt management server 10 via the communication network N1 (“electronic receipt information (S1)”).

In the return transaction, electronic return receipt information obtained by digitizing the return information is generated and transmitted to the electronic receipt management server 10 (“return receipt (S7)”).

The mobile device 12 is an information processing apparatus that is used by a consumer inside or outside a house of the consumer.

An example of the mobile device 12 includes a mobile information processing apparatus that has a wireless communication function, such as a portable telephone, a smartphone, or a tablet terminal. Further, an example of the mobile device 12 includes a fixed information processing apparatus, such as a personal computer, connected to a router or the like connected to a network. Hereinafter, the mobile device 12 will be described as a mobile information processing apparatus.

The mobile device 12 accesses the electronic receipt management server 10 via the communication network N2. Through this access, the mobile device 12 makes various requests to the electronic receipt management server 10. The requests include, for example, a request for the electronic receipt information (“displaying request (S2)”). After the electronic receipt information is acquired, a request for a merchandise code (“merchandise code request (S4)”) correlated with a merchandise name may be made.

The mobile device 12 includes a viewer to display the electronic receipt information.

When the request for the electronic receipt information is transmitted to the electronic receipt management server 10 (“displaying request (S2)”), the electronic receipt information is extracted in the electronic receipt management server 10 and the format of the electronic receipt information is converted into a predetermined display format. Then, for example, at this time, the electronic receipt information to which the event generation trigger is embedded is generated as display data. The mobile device 12 displays the electronic receipt information to which the event generation trigger is embedded on the display screen of the mobile device 12 with the viewer (“acquire electronic receipt information (S3)”).

Thereafter, the consumer is assumed to operate the event generation trigger, for example, by tapping the event generation trigger on the display screen of the mobile device 12 (“merchandise code request (S4)”). Then, the electronic receipt management server 10 executes a process correlated with the trigger, that is, acquires the merchandise code data. As a result of the process, the mobile device 12 acquires the merchandise code data correlated with the merchandise name data included in the electronic receipt information (“acquire merchandise code (S5)”). The mobile device 12 displays the acquired merchandise code data on the display screen or stores the acquired merchandise code data in a predetermined storage region so that the merchandise code data is read by the POS terminal 11 (“read merchandise code (S6)”).

Hereinafter, a way of displaying barcode information as the merchandise code data on the display screen of the mobile device 12 and causing the POS terminal 11 to read the barcode information will be described as an example. Barcode information of the merchandise code data is assumed to be registered in advance in the merchandise code file 100 of the electronic receipt management server 10.

Further, in the following embodiment, the event generation trigger is embedded in the electronic receipt information when the format of the electronic receipt information is converted into the display format of the mobile device.

Next, the configuration and an operation of main apparatuses in the electronic receipt system 1 will be described in detail.

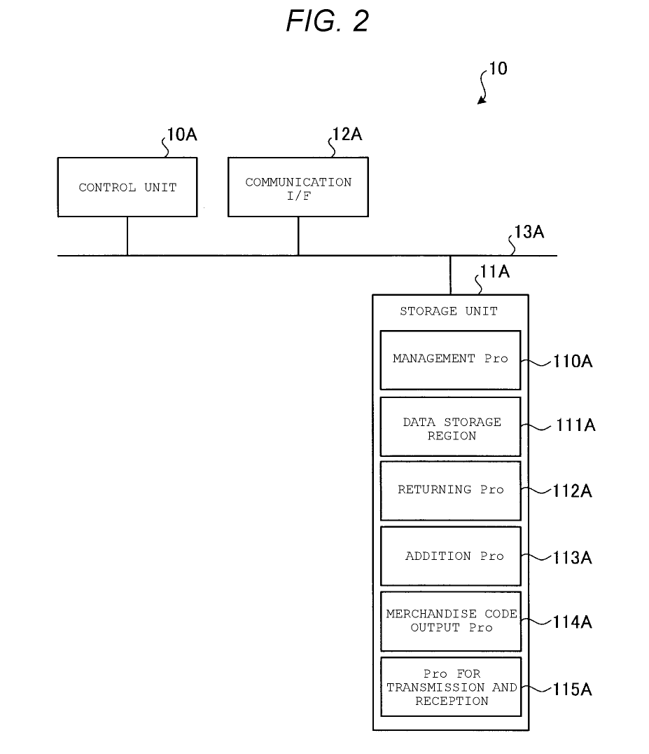

FIG. 2 is a block diagram of the electronic receipt management server 10. The electronic receipt management server 10 mainly includes a control unit 10A, a storage unit 11A, and a communication I/F 12A. These units are connected to each other via a bus 13A.

The control unit 10A is a computer that integrally controls the units of the electronic receipt management server 10 and executes arithmetic calculation and control of input and output of data. The control unit 10A includes a central processing unit (CPU), a read-only memory (ROM) that stores various programs or data, a random access memory (RAM) that serves as a work memory loading various programs, rewriting data, and storing data freely, and a real-time clock (RTC) portion that indicates a current date and time.

The storage unit 11A is, for example, an auxiliary storage device such as a hard disk drive (HDD) or a solid state drive (SSD).

The storage unit 11A stores various programs or data. By executing the various programs or data stored in the storage unit 11A, the ROM, or the like by the CPU of the control unit 10A, the electronic receipt management server 10 functions as an electronic receipt management section, the addition section 101 (see FIG. 1), the electronic receipt information output section 102, the merchandise code output section 103 (see FIG. 1), or the like.

The database DB1 (see FIG. 1) and a management program (a “management program” is abbreviated to “Pro” in the drawing) 110A to manage the database DB1 are stored in the storage unit 11A. A storage region 111A in the storage unit 11A stores various data of the database DB1. The various data include the electronic receipt information and its management information (for example, individual data included in the electronic receipt information or key information specifying the electronic receipt information). The management program 110A is executed by the CPU to manage such various data as a table. Here, for example, the database DB1 is assumed to include a plurality of tables including the following tables.

One table included in the database DB1 is a management table (not illustrated) of the electronic receipt information. In the management table, the electronic receipt information and the management data (for example, a member ID, a receipt No., a transaction date, a store code, and a registration No.) are correlated with each other, so that the electronic receipt information is managed as management data. The management table includes a single table or a plurality of tables.

Another table included in the database DB1 is a merchandise code table, which is an example of the merchandise code file 100. In the merchandise code table, the merchandise code data and the merchandise name data are correlated with each other to manage the merchandise name data. The merchandise code data correlated with the merchandise name data is searched using the merchandise name data as a search key.

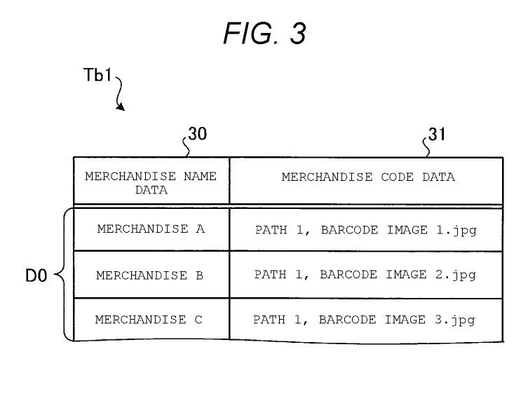

FIG. 3 illustrates a data structure of a merchandise code table Tb1. As illustrated in FIG. 3, the merchandise code table Tb1 includes items of “merchandise name data” 30 and “merchandise code data” 31.

The first row of FIG. 3 indicates an item name and the second and subsequent rows indicate a data portion D0. In the data portion D0, only three merchandises are illustrated and others are omitted.

In the data portion D0 of the “merchandise name data” 30, merchandise name data (product A, product B, product C, and the like) acquired from merchandise master data (not illustrated) are set. For example, the merchandise master data are acquired from the POS terminal 11 or a store server, a headquarter server, or the like.

In the “merchandise code data” 31 of the data portion D0, merchandise code data correlated to the data set in the “merchandise name data” 30 is set.

In the present embodiment, standardized codes are used as the merchandise code data. The standardized codes include Japanese Article Number (JAN) codes used in Japan, European Article Number (EAN) codes used in Europe or the like, and Universal Product Code (UPC) codes used in the United States. Other codes such as company-unique merchandise codes may be used.

The merchandise name data and the merchandise code data are correlated with the merchandise master data. Accordingly, merchandise code data of the merchandise master data are used as the merchandise code data.

In the present embodiment, for example, a barcode image of a 2-dimensional barcode is used as the merchandise code data. For this reason, in the data portion D0 of the “merchandise code data” 31, the merchandise code data such as the JAN codes are not set, but a path and the file name of a barcode image indicating a recording destination of the barcode image are set. For the barcode image, merchandise code data such as a JAN code is converted into a 2-dimensional barcode image in advance, and the 2-dimensional barcode image is recorded as an image picture in a format such as JPEG in a directory indicated by a path. Here, a barcode image (filenames: barcode image 1.jpg, barcode image 2.jpg, barcode image 3.jpg, and the like) of each product is stored in one directory of path 1.

The management program 110A of the storage unit 11A illustrated in FIG. 2 is executed to manage various data stored in the database DB1 as a table and an operation or the like on the various data. Specifically, the management program 110A is executed to search the database DB1 in response to a request from an external apparatus such as the POS terminal 11 or the mobile device 12 and execute processes such as data extraction, registration, update, and deletion. For example, when the electronic receipt information received from the POS terminal 11 includes a value of process mode “0,” the electronic receipt information is determined to be electronic receipt information, and a normal registration process is executed. When the electronic receipt information includes a value of process mode “1,” the electronic receipt information is determined to be electronic return receipt information, and a return process, which is one of additional processes, is executed. During the return process, a process such as extraction or updating of data is executed in cooperation with a return program.

The storage unit 11A also stores a return program 112A as a program to carry out one of the additional processes. The return program 112A is executed when the management program 110A is executed to process the electronic receipt information as the electronic return receipt information. In cooperation with the management program 110A, the return program 112A is executed to extract the electronic receipt information indicating content of corresponding original transaction from the database DB1 based on an “original transaction number,” a “store code,” a “member ID,” or the like included in the electronic return receipt information. Then, the registration content of the electronic receipt information of the original transaction in the database DB1 is updated by processing the extracted electronic receipt information, such as setting of adding a cancellation line (deletion mark) to the merchandise name to be returned.

The storage unit 11A further stores a transmission and reception program 115A. The transmission and reception program 115A includes a program for executing data communication with the POS terminal 11 or the mobile device 12 according to a predetermined protocol (HTTP or the like).

Further, the transmission and reception program 115A includes a program to perform format conversion so that the electronic receipt information can be displayed on the mobile device 12 and transmits various information to the mobile device 12 when a request for displaying the electronic receipt information is made from the mobile device 12. This program causes the management program 110A to extract the electronic receipt information when the request for displaying the electronic receipt information is made from the mobile device 12. Then, addition of the event generation trigger, format conversion, or the like is executed by an addition program. Then, for example, some or all of the processed electronic receipt information are transmitted to the mobile device 12 that sent the display request, so that the electronic receipt information with the event generation trigger can be displayed on the mobile device 12.

Moreover, the transmission and reception program 115A includes a program to transmit necessary information that enables the merchandise code is displayed on the mobile device 12, including the merchandise code data, to the mobile device 12 when a request for acquiring the merchandise code is made by operation of the event generation trigger.

The storage unit 11A further stores an addition program 113A and a merchandise code output program 114A.

The addition program 113A is executed to add the event generation trigger, by which an additional request such as a request for acquiring the merchandise code is made by the mobile device 12, to the electronic receipt information when a request for displaying the electronic receipt information is made from the mobile device 12. As a method of adding the event generation trigger, for example, information (the event generation trigger) that includes a path indicating a destination of a program described by JAVASCRIPT (registered trademark), PHP (PHP Hyper Text preprocessor), or the like and generates an operational signal is embedded in a structured document such as HyperText Markup Language (HTML). The structured document is set such that the merchandise name data of the electronic receipt information is acquired as a search key by the electronic receipt management server 10 when the event generation trigger is operated.

The merchandise code output program 114A is activated when the event generation trigger added to the electronic receipt information displayed on the mobile device 12 is operated. For example, the merchandise code output program 114A is configured as a program of a server side such as PHP or JAVASCRIPT stored in a location indicated by the path.

In the present embodiment, when the event generation trigger is operated, the merchandise code output program 114A correlated with the event is activated. The merchandise code output program 114A is executed to extract a file name and a path indicating a stored location of the merchandise code data from the database DB1 using the merchandise name data included in the electronic receipt information, in cooperation with the management program 110A. Then, the merchandise code output program 114A is executed to generate display data of the merchandise code data (that is, a barcode image) to be displayed on the display screen of the mobile device 12. Specifically, the display data is generated by setting the file name and the path extracted from the database DB1 with a tag indicating an image in an HTML document for a reply. An HTML screen for a reply is output to the mobile device 12 through HTTP communication and a barcode image designated by the file name and the path in the HTML screen is output.

The communication I/F 12A is a network interface connected to the communication networks N1 and N2. In the present embodiment, by executing the transmission and reception program 115A, connection to the communication network N1 is established to communicate with the POS terminal 11. Further, connection to the communication network N2 is established to communicate with the mobile device 12.

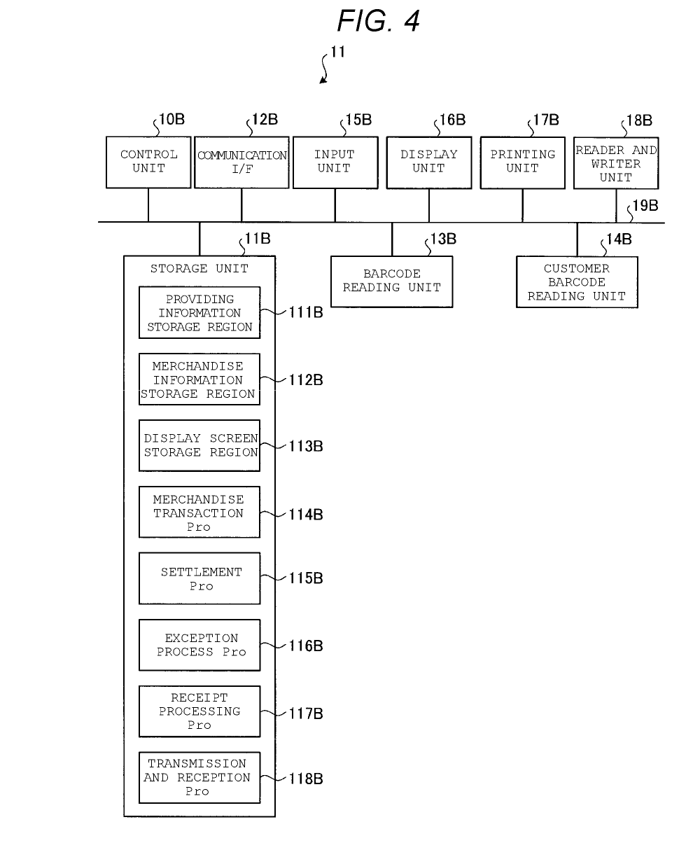

FIG. 4 is a block diagram of the POS terminal 11.

The POS terminal 11 mainly includes a control unit 10B, a storage unit 11B, a communication I/F 12B, a barcode reading unit 13B, a customer barcode reading unit 14B, an input unit 15B, a display unit 16B, a printing unit 17B, and a reader and writer unit 18B. The units are connected to each other by a bus 19B.

The control unit 10B is a computer that integrally controls various arithmetic calculations and the units of the POS terminal 11 and executes arithmetic calculation and controlling of input and output of data. The control unit 10B includes a CPU, a ROM that stores various programs or data, a RAM that serves as a work memory loading various programs, rewriting data, and storing data freely, and a RTC portion that indicates a current date and time.

The input unit 15B converts, for example, a physical operation such as pushing down an input key by a cashier into an electric signal to the CPU. For example, when a cashier pushes down an input key, the input unit 15B inputs operation content assigned to the input key as an electric signal of a command, data, or the like to the CPU. The input keys include a merchandise key correlated with a product, a numeric key used to input a merchandise code, and a command key with which a command is assigned. The command key is, for example, a sum key, a return key, a correction key, a registration minus key, or the like.

The barcode reading unit 13B reads a barcode through irradiation of an infrared ray and decodes the read barcode into a predetermined code. Here, a reading target is set to a barcode attached to a merchandise tag. When the reading ends, the barcode is decoded into a merchandise code.

The customer barcode reading unit 14B is a reading unit configured to read the merchandise code data.

The customer barcode reading unit 14B reads a barcode image displayed on the display screen of the mobile device 12 and decodes the barcode image into a predetermined code. Here, a barcode image of a member ID and a barcode image of a merchandise code are read as barcode images and are decoded into the member ID formed by alphanumeric characters, signs, and the like and the merchandise code such as a JAN code.

The display unit 16B includes a display screen such as a liquid crystal display and displays display data on the display screen. Merchandise information such as the prices of products input using input keys by a cashier or read with the barcode reading unit 13B are displayed sequentially on the display screen. Further, settlement information such as total price and changes are displayed.

The reader and writer unit 18B reads and writes card information from a card with which electronic money settlement or IC card settlement is executed.

The printing unit 17B prints printing data on a receipt sheet. When the printing unit 17B receives various printing data indicating content, return, or the like of a transaction from the CPU, the printing unit prints content of the printing data on a receipt sheet. The printing unit 17B prints the content of the printing data sequentially from an end portion of a receipt sheet in a roll shape through a predetermined printing method such as ejection, thermal transfer, or the like of ink.

The storage unit 11B is an internal memory or a detachable external storage device (for example, a flash memory or an HDD).

In the storage unit 11B, a storage region 111B of information regarding providing positions of a store code, a registration No., and the like, a storage region 112B of merchandise information related to merchandise transaction, such as merchandise master data, and a storage region 113B of a display screen are provided. In the storage regions 111B, 112B, and 113B, predetermined information is appropriately set, for example, when a store is provided. The storage unit 11B further stores a merchandise transaction program 114B, a settlement program 115B, an exception process program 116B, a receipt processing program 117B, and a transmission and reception program 118B.

The merchandise transaction program 114B is executed to perform a (normal) merchandise transaction.

The settlement program 115B is executed to perform settlement processing.

The exception process program 116B is executed to perform additional processes other than the normal merchandise transaction. Specifically, the additional processes include the return process, the registration minus process, the correcting process, or the like.

The receipt processing program 117B is executed to print a sheet receipt after a transaction ends or an additional process ends and generate electronic receipt information for a member.

When the receipt processing program 117B is executed at the time of returning a product, the POS terminal 11 functions as an electronic return receipt generation section. The electronic return receipt generation section generates electronic return receipt information regarding a returned product based on the merchandise code data read by the reading section.

The transmission and reception program 118B includes a program to perform data communication in accordance with a predetermined protocol (HTTP or the like) with the electronic receipt management server 10. The transmission and reception program 118B further includes a program to communicate with a settlement center.

The communication I/F 12B is a network interface that is connected to a communication network. In the present embodiment, the communication I/F 12B is connected to the communication network N1 to transmit the electronic receipt information to the electronic receipt management server 10. At the time of the normal transaction, the electronic receipt information is transmitted. At the time of the return transaction, the electronic return receipt information generated by the electronic return receipt generation section is transmitted to the electronic receipt management server 10. When the electronic receipt information is not received in the electronic receipt management server 10, a retry process is performed. Further, communication with the settlement center (not illustrated) is performed to complete the settlement.

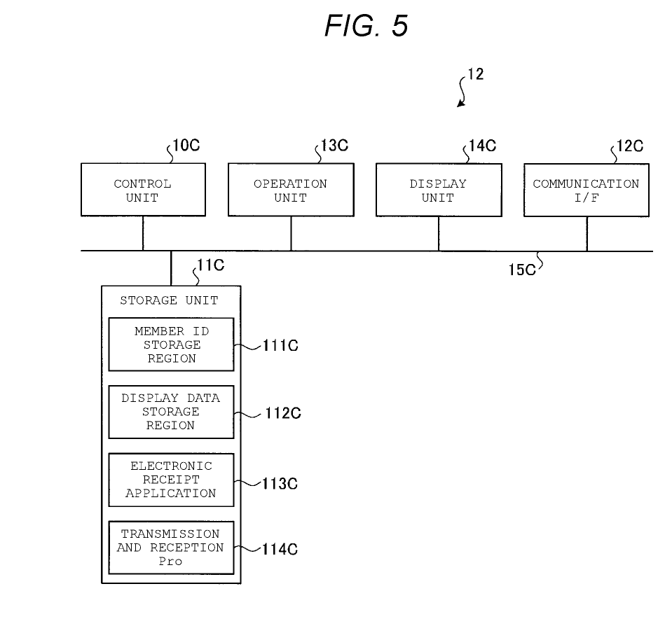

FIG. 5 is a block diagram of the mobile device 12. The customer terminal 12 mainly includes a control unit 10C, a storage unit 11C, a communication I/F 12C, an operation unit 13C, and a display unit 14C. The units are connected to each other by a bus 15C.

The control unit 10C is a computer that collectively controls various arithmetic calculations and the units of the mobile device 12 and executes arithmetic calculation and controlling of input and output of data. The control unit 10C includes a CPU, a ROM that stores various programs or data, a RAM that serves as a work memory loading various programs, rewriting data, and storing data freely, and a RTC portion or the like that indicates a current date and time.

In the present embodiment, the operation unit 13C is an input device that converts an operation such as tapping, flicking, or pinching (pinch-out or pinch-in) on a touch input type display screen into a predetermined input signal and inputs the input signal to the control unit 10C. For example, when a link character or a link image displayed on the display screen to acquire the merchandise code data is tapped, an interrupt signal is input to the control unit 10C to give an instruction to execute event processing assigned to an object (command) at a tapped coordinate position.

The display unit 14C displays display data generated by the control unit 10C, display data acquired from the electronic receipt management server 10, or the like on the display screen. A liquid crystal screen or the like is included as the display screen.

The communication I/F 12C is a communication interface that is connected to the communication network N2 to access the Internet over a portable telephone network or the like.

The storage unit 11C is an internal memory or a detachable external storage device (for example, a flash memory). The storage unit 11C stores a storage region 111C of a member ID, a storage region 112C of display data, an application 113C for an electronic receipt, and a transmission and reception program 114C.

In the storage region 111C of the member ID, a member ID acquired through member registration and formed of a combination of alphanumeric characters and signs or a barcode image generated by converting the member ID are stored.

The storage region 112C of the display data is a region in which display data displayed on the display screen is stored. Here, display data generated by the own device or display data (for example, a barcode image of the merchandise code data) acquired from the electronic receipt management server 10 is stored.

The application 113C for the electronic receipt includes a selection program to select and designate desired electronic receipt information or a viewer of the electronic receipt information.

The selection program is executed to designate conditions to extract the desired electronic receipt information from a plurality of certain electronic receipt information, and make a request to the electronic receipt management server 10. For example, the electronic receipt information is narrowed down by a transaction date or a transaction store as the conditions.

The viewer is a web browser to display the electronic receipt information that is extracted in the electronic receipt management server 10 and converted into a predetermined display format. In the present embodiment, the electronic receipt information to which the event generation trigger is added is displayed. A barcode image is displayed as the merchandise code data.

The viewer analyzes the syntax of an HTML document acquired from the electronic receipt management server 10 and displays electronic receipt information with the event generation trigger or a barcode image in a predetermined layout on the display screen of the mobile device 12.

For a user to visually recognize a user operation of the event generation trigger, for example, a plug-in may be embedded into the viewer so that an animation indicating that the user operation is executed is displayed. An animation effect by which the user operation can be visually recognized on the mobile device 12 may be achieved by setting a cascading style sheets (CSS) or the like.

The transmission and reception program 114C is executed to perform data communication in accordance with a predetermined protocol (HTTP or the like) with the electronic receipt management server 10. Various request information or the like in the communication are transmitted to the electronic receipt management server 10. Further, reply information or the like from the electronic receipt management server 10 is received.

Next, an operation of each apparatus will be described.

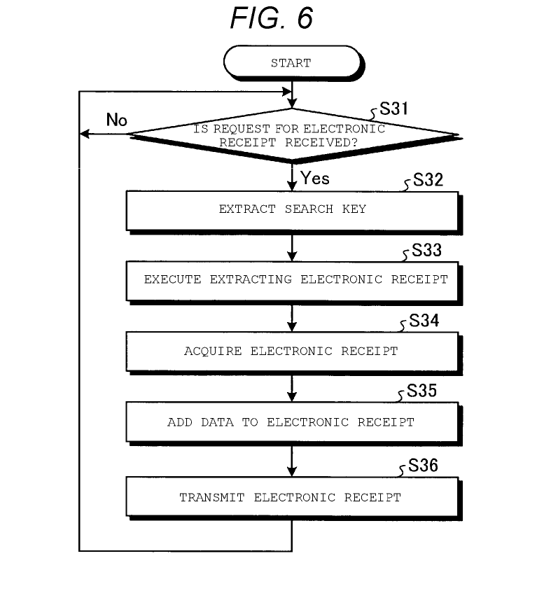

FIG. 6 is a flowchart illustrating a process to output the electronic receipt information carried out by the electronic receipt management server 10.

This process is executed in the following order by the CPU by reading various programs stored in the electronic receipt management server 10.

First, it is determined whether a request for the electronic receipt information is received from the mobile device 12 (S31). When the request for the electronic receipt information is determined to be not received in step S31 (No determination), the process stays on standby until the reception. Conversely, when the request for the electronic receipt information is determined to be received in step S31 (Yes determination), a search key included in the transmission request and is used to extract the electronic receipt information is extracted (S32). As the search key, data of a “member ID,” a “transaction date,” a “use store,” or the like can be used.

Next, the electronic receipt information is extracted using the search key (S33). In the extraction, for example, an extraction command by an SQL text or the like is generated, the database DB1 is searched, and then the search result is returned.

When electronic receipt information of a JavaScript Object Notation (JSON) format is stored in the database DB1, the electronic receipt information of the JSON format is returned.

Next, the electronic receipt information returned as a result of step S33 is acquired and loaded on a storage region such as a RAM (S34).

Next, the display data is generated, for example, by converting the format of the electronic receipt information in accordance with an environment of the mobile device 12 or adding the event generation trigger (S35).

Then, some or all of the display data are transmitted, as a reply to the request, to the mobile device 12 that sent the request (S36), and the process returns to step S31.

For example, the event generation trigger is added as follows.

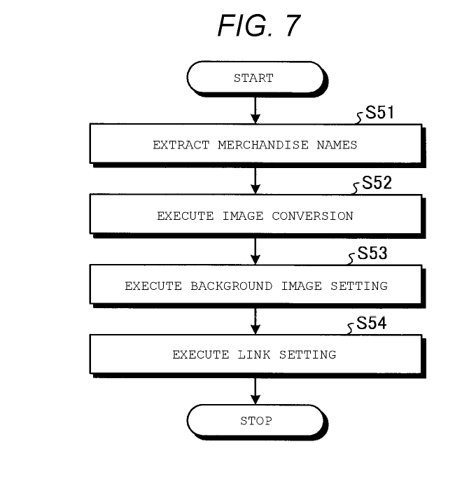

FIG. 7 is a flowchart illustrating the addition of the event generation trigger. This process is executed in the following order by the CPU by reading various programs stored in the electronic receipt management server 10.

First, the electronic receipt information (JSON data or the like) extracted from the electronic receipt management server 10 is analyzed from the beginning of the data to extract all of the merchandise name data. Numbers (1st to n-th) are assigned in an extraction order to the pieces of extracted merchandise name data to be managed with a table or the like (S51).

Next, the format of the original electronic receipt information (JSON data or the like) including the merchandise name data is converted to generate image data (electronic receipt image) and stored in a predetermined directory (S52).

Next, in an HTML document for a reply to the mobile device 12, the electronic receipt image is set in a background image or the like (S53).

Further, in the HTML document, a link character or a link image is set on the electronic receipt image (S54).

For example, when an icon is set as the link image in the vicinity of an n-th piece of merchandise name data, the icon is registered in the directory, and coordinates in the vicinity of the merchandise name data and a reaction range of the icon are set in a tag as the display position and the reaction region of the icon.

The icon is displayed in the vicinity (for example, the upper, lower, left, or right) of the display position of the n-th piece of merchandise name data on the electronic receipt image through the setting of the tag and a region indicated by the icon becomes the reaction region of the link.

A path of a link destination is set in the tag. As the path of the link destination, a path indicating a stored location of a program (a program such as JAVASCRIPT or PHP) to extract the merchandise code data is set.

Further, the n-th piece of merchandise name data is set from the pieces of merchandise name data extracted in step S51 and managed by a number, as the key information delivered to a program of a link destination. Through the setting of the path and the key information, a process designated in the link destination when the user operates the icon is executed based on the key information.

The above-described setting is executed on the 1st to n-th pieces of the merchandise name data.

As described above, the display data is generated, for example, by adding the event generation trigger and executing the format conversion into the display format of the mobile device 12.

The above-described setting method is merely an example. As long as the link character or the link image correlated with the merchandise code data may be set, appropriate modification may be made or another method may be executed.

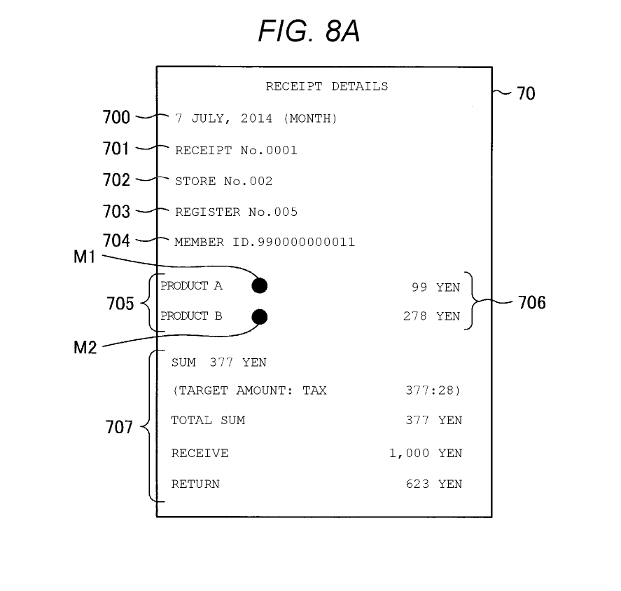

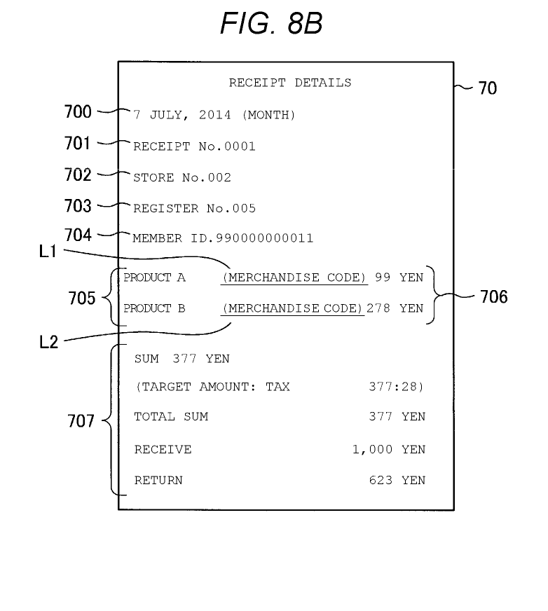

FIGS. 8A and 8B illustrate display examples of the electronic receipt information displayed on the mobile device 12, to which the event generation trigger is added.

FIG. 8A illustrates a display example of the electronic receipt information to which icons are added as the event generation trigger. In FIG. 8A, electronic receipt information 70 is displayed as a background image.

The electronic receipt information 70 includes, as display information, items of “transaction date” 700, “receipt No” 701, “store code” 702, “register No” 703, “member ID” 704, “merchandise name” 705, “merchandise price” 706, and “accounting information” 707. In each time, each piece of correlated information is displayed. For example, two transacted products (product A and product B) are displayed as merchandise names in the “merchandise name” 705.

In the electronic receipt information 70, icons M1 and M2 are displayed as the event generation triggers to acquire the merchandise code data in the vicinity of the merchandise name data (product A and product B) (here between the “merchandise name” 705 and the “merchandise price” 706). To indicate the event generation trigger, for example, icons intuitively recognized by color or design or icons that include a character string such as “merchandise code” may be appropriately displayed.

When one of the icons M1 and M2 is tapped (selected), the merchandise code data of the merchandise name data (the product A or the product B) corresponding to the tapped icon is acquired from the electronic receipt management server 10. Further, an animation, e.g., changing a display form of the icon, may be appropriately displayed so that the user can visually recognize that the icon is selected.

FIG. 8B illustrates a display example of the electronic receipt information displayed on the mobile device 12, to which link characters are added as the event generation triggers. In FIG. 8B, the same numbers are used for the common regions to those in FIG. 8A.

In the electronic receipt information 70 in FIG. 8B, link characters L1 and L2 are added as the event generation triggers to acquire the merchandise codes in the vicinity of the merchandise names (product A and product B). A character string “merchandise code” is used as the link character.

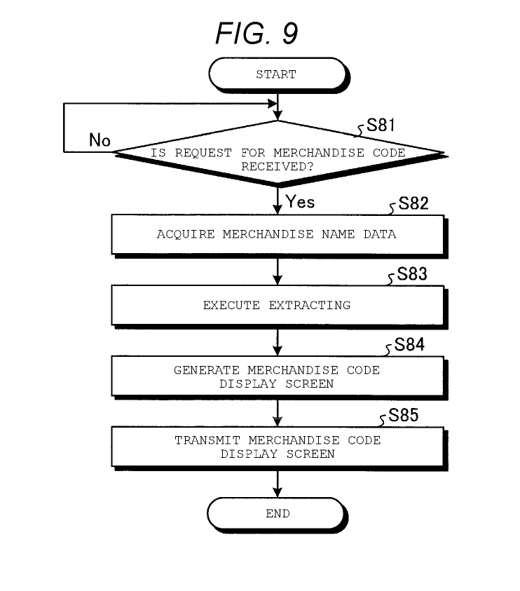

FIG. 9 is a flowchart illustrating a process to output merchandise code carried out by the electronic receipt management server 10. This process is executed in the following order when various programs stored in the electronic receipt management server 10 are executed by the CPU.

First, it is determined whether a request for the merchandise code is received from the mobile device 12 (S81). The transmission request includes the merchandise name data as key information and is transmitted to the electronic receipt management server 10 when the user taps one icon, which is the event generation trigger, on the display screen of the mobile device 12.

When the request for the merchandise code is determined to be received in step S81 (Yes determination), the merchandise name data is acquired as the key information (S82).

Next, an extraction process using the merchandise name data as a search key is performed (S83). In the extraction process, for example, an extraction command by an SQL text or the like using the merchandise name data as the search key is generated, the database DB1 is searched, and the search result are returned. In the present embodiment, the path and the file name of one barcode image in the merchandise name data are correlated with each other in the merchandise code table Tb1 of the database DB1. Accordingly, in this case, the path and the file name of the correlated barcode image are returned.

Next, the display data of the merchandise code is generated by setting the path and the file name of the barcode image returned as a result of step S83 in an HTML document for reply (S84). The HTML document for reply is, for example, a structured document including a barcode image and a return button. A display size of the barcode image is set such that the barcode can be scanned by a barcode scanner when displayed on the display screen of the mobile device 12. The display data is generated by setting the path and the file name in a tag indicating the barcode image.

After step S84, the generated display data is transmitted to the mobile device 12 that sent the request (S85), and the process ends.

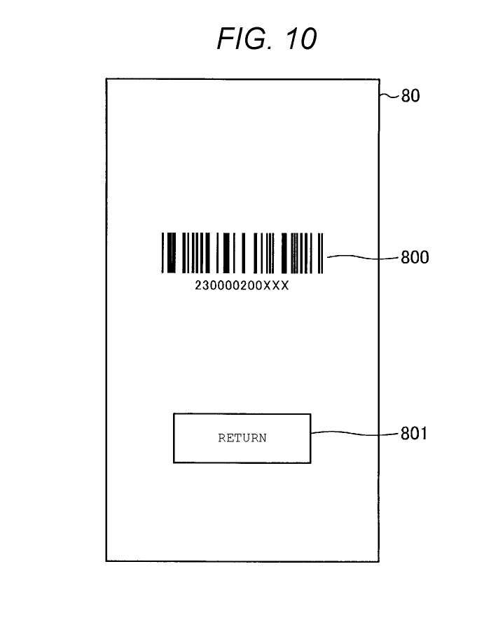

FIG. 10 illustrates a screen displayed on the mobile device 12 according to the display data generated in the process in FIG. 9.

A screen 80 is a screen displayed when the icon M1 (or the icon M2) is selected on the electronic receipt information 70 illustrated in FIGS. 8A and 8B. A barcode image 800 in the screen 80 corresponds to the merchandise code of the product A (or the product B) correlated with the icon M1 (or the icon M2). The barcode image 800 has a predetermined size, a predetermined resolution, and black and white binary values so as to be scanned using a customer barcode scanner of the POS terminal 11.

In the screen 80, a return button 801 is displayed. Operation of the return button 801 causes the screen to return to the electronic receipt information 70.

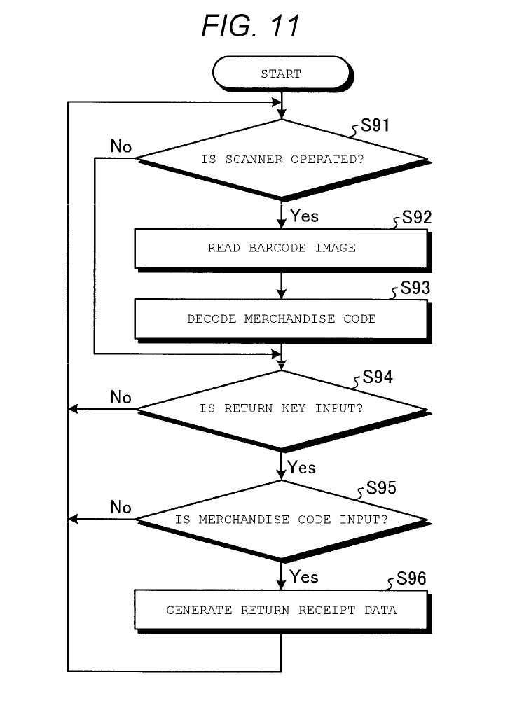

FIG. 11 is a flowchart illustrating the return process carried out by the POS terminal 11. This process is carried out in the following order by the CPU, by reading various programs stored in the POS terminal 11.

First, it is determined whether or not a customer barcode reading device is operated (S91). For example, this determination is performed by detecting an operation by a casher, that a scanner unit of the customer barcode reading device is detached from a predetermined set position, that a trigger of a mechanic operation unit of the scanner unit is pulled, or that the power of the scanner unit is turned on. Accordingly, when the operation is detected, Yes determination is made in step S91.

When Yes determination is made in step S91, a barcode image of a merchandise code displayed on the display screen of the mobile device 12 is read by the customer barcode reading device (S92).

Next, the read barcode image is decoded into a merchandise code of alphanumeric characters, according to a predetermined decoding order determined in advance, and the merchandise code is stored in the storage unit (S93).

Next, it is determined whether or not a return key is operated (S94). In this process, when the return key has been operated before step 93, a flag indicating the operation is set. In step S94, the determination is executed with reference to the flag state.

When it is determined in step S94 that the return key is operated (Yes in S94), then whether or not the merchandise code is input is determined (S95).

In step S95, it is determined whether or not the merchandise code is stored in the storage unit through an input from the customer barcode reading device, another barcode reading device, an input key, or the like. When step S93 is executed, the merchandise code is stored through the input from the customer barcode reading device, and thus Yes determination is made. When Yes determination is made in step S95, the electronic return receipt information including the return information such as the merchandise code is generated and set in a transmission memory (S96). At this time, transaction mode “1” indicating the return of a product is assigned as the process mode of the electronic return receipt information. The electronic return receipt information set in the transmission memory is transmitted sequentially to the electronic receipt management server 10.

After the electronic return receipt information is generated, the merchandise code data is deleted from the storage unit and the process returns to step S91.

Conversely, when it is determined in step S94 that the return key is not operated (No determination), the process returns to step S91. The return of a second product is executed in this cycle. The returning of the second product is executed similarly, that is, by reading the barcode image of the merchandise code of the product to be returned from the display screen of the mobile device 12 and storing the merchandise code data in the storage unit. Then, when it is determined in step S94 that the return key is operated, the electronic return receipt information including the merchandise codes of the plurality of products is generated.

When No determination is made in step S91, the process proceeds to step S94.

When No determination is made in step S95, the process proceeds to step S91.

In the present embodiment, the acquiring of the merchandise code data on the server side is executed based on an operation of the event generation trigger on the mobile device. However, the embodiment may be modified in such a manner that only the extraction of the merchandise code data is executed on the server side and the other processes, including generation of the screen, are executed on a client side. Further, the embodiment may be appropriately modified so that the processes are portioned to the server and the client.

In the present embodiment, the event generation trigger such as an icon is correlated for each product as an example on the electronic receipt information, but the present embodiment is not limited to this form. For example, one event generation trigger may be provided in one piece of electronic receipt information and the merchandise codes of all products including the electronic receipt information may be acquired by operating the event generation triggers.

In the present embodiment, although the link image or the link character is used as the event generation trigger, the present embodiment is not limited thereto. In addition, for example, a button or the like used to trigger the process to acquire the merchandise code or execute some or all of the processes may be used as the event generation trigger.

In the present embodiment, although the electronic receipt management server stores the barcode information as the merchandise code data in the storage unit and the mobile device acquires the barcode information, the present embodiment is not limited thereto. The embodiment may be modified in such a manner that the electronic receipt management server stores the merchandise code (a data string indicating alphanumeric characters such as the JAN code) as the merchandise code data, the mobile device acquires the merchandise code, and the merchandise code is encoded into the barcode information on the mobile device side.

For example, the electronic receipt management server may store the merchandise code data of alphanumeric characters such as the JAN code, and the mobile device may acquire the merchandise code data and display the merchandise code data on the display screen in this form. In this case, a cashier can look at display content and input the merchandise code with an input key.

The merchandise code data may be stored in the storage unit of the mobile device and the merchandise code data may be read by the POS terminal through short-range wireless communication or the like.

In the present embodiment, the information such as the electronic receipt information or the merchandise code data in a structured format such as HTML is acquired by the mobile device, and the information based on the structured document is displayed on the display screen of the mobile device. However, the present embodiment is not limited thereto. The present embodiment may be modified in such a manner that a dedicated viewer of the electronic receipt information is installed to the mobile device and screen information including the electronic receipt information or the merchandise code data in a unique format which can be displayed by only the dedicated viewer may be transmitted from the electronic receipt management server to the mobile device.

In the present embodiment, the section (the merchandise code file, the addition section, the electronic receipt information output section, the merchandise code output section, or the like) to acquire the merchandise code using a merchandise name is provided in the electronic receipt management server. However, the present embodiment is not limited thereto. For example, in a communication route from the POS terminal to the electronic receipt management server, a merchandise code file and an addition section may be provided in a relay apparatus relaying the electronic receipt information and information obtained by adding the event generation trigger to the electronic receipt information may be transmitted to the electronic receipt management server. Further, a merchandise code output section may be provided in the relay apparatus, the mobile device may access the relay apparatus, and the merchandise code may be acquired.

The relay apparatus can be applied to a store server that collectively manages a plurality of POS terminals provided in a store and a company headquarter server that collectively manages a plurality of store servers.

In the present embodiment, the merchandise code data is acquired as one piece of the supplementary information from the electronic receipt information displayed on the mobile device, and the information may be displayed on the screen of the mobile device. However, other supplementary information may be acquired and displayed by the mobile device. Other examples of the supplementary information include traceability information and allergy information regarding products.

In this case, the “merchandise code data” can be replaced with the “traceability information” (or the “allergy information”). In the electronic receipt management server, the “traceability information” (or the “allergy information”) is stored in a file in correlation with the merchandise name data. The link image or the link character, which is the displayed event generation trigger of the mobile device, is changed into “traceability information” (or the “allergy information”). The image includes an illustration or a character image depicting the “traceability information” (or the “allergy information”). The character includes a character string of the “traceability information” (or the “allergy information”). The present embodiment is not limited thereto. The present embodiment may be modified such that another piece of merchandise information is supplied as supplementary information to a consumer.

In addition to the merchandise information, an application can also be made such that a consumer is invited to a designated web site. In this case, in the electronic receipt management server, invitation information (supplementary information) of a web site is recorded in a file in correlation with the merchandise name data. The invitation information is set as an HTML document serving as a reply screen to the mobile device and a Uniform Resource Identifier (URI) of an invitation destination is included as link information in this document. When the event generation trigger is operated from the mobile device, the correlated invitation information is extracted and the invitation information is displayed as a reply screen on the mobile device. When a consumer is interested, the consumer can view the web site of the designated destination by designating the link included in the invitation information.

Various programs used in the various apparatuses according to the present embodiment may be recorded in files in an installable format or an executable format in computer-readable recording media such as a CD-ROM, a flexible disc (FD), a CD-R, and a Digital Versatile Disk (DVD) to be supplied, and may be read to flash ROMs or the like of various apparatuses to be executed.

The program may be stored on a computer connected to a network such as the Internet and may be downloaded via the network to be supplied.

According to the present embodiment, the supplementary information of the merchandise name can be simply acquired using the electronic receipt information viewed by a consumer. Accordingly, for example, when a product is returned, the corresponding merchandise code can be displayed on the mobile device by acquiring the merchandise code as supplementary information through an operation of the trigger on the electronic receipt information even when the merchandise code of the product is not known. Further, by displaying the barcode image as the merchandise code on the display screen, the POS terminal can read the barcode image with the customer barcode reading device. Therefore, the return process of a product can be more efficiently performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A register comprising:
a scanner configured to optically scan a code symbol displayed on a display of a computing device;
a communication interface; and
a controller configured to
determine a product code based on the scanned code symbol,
generate an electronic purchase receipt including the product code when operating in a registration mode,
generate an electronic return receipt including the product code when operating in a return mode, and
control the communication interface to transmit the generated electronic purchase receipt and the generated electronic return receipt to a server.

2. The register according to claim 1, further comprising:
an operation key operable by a user, wherein
the controller is further configured to set an operational mode thereof to the return mode in response to a user operation of the operation key.

3. The register according to claim 1, wherein
the electronic purchase receipt includes a first value indicating that a type thereof is a purchase receipt, and
the electronic return receipt includes a second value indicating that the type thereof is a return receipt.

4. The register according to claim 3, wherein
the first value and the second value are each a one-digit value.

5. The register according to claim 1, further comprising:
a data storage, wherein
the controller is configured to store the product code in the data storage each time the controller determines the product code, and generate the electronic return receipt so as to include each product code stored in the data storage.

6. A method for generating and processing product registration data using a register, comprising:
determining a product code based on a code symbol scanned by a scanner of the register;
generating an electronic purchase receipt including the product code and transmitting the generated electronic purchase receipt to a server, when the register is operating in a registration mode; and
generating an electronic return receipt including the product code and transmitting the generated electronic return receipt to the server, when the register is operating in a return mode.

7. The method according to claim 6, wherein the register includes an operation key operable by a user, the method further comprising:
setting an operational mode of the register to the return mode in response to a user operation of the operation key.

8. The method according to claim 6, wherein
the electronic purchase receipt includes a first value indicating that a type thereof is a purchase receipt, and
the electronic return receipt includes a second value indicating that the type thereof is a return receipt.

9. The method according to claim 8, wherein
the first value and the second value are each a one-digit value.

10. The method according to claim 6, further comprising:
storing the product code in a data storage of the register, each time the product code is determined, wherein
the electronic return receipt is generated so as to include each product code stored in the data storage.

11. A non-transitory computer readable medium comprising a program that is executable in a register to cause the register to perform a method for generating and processing product registration data, the method comprising:
determining a product code based on a code symbol scanned by a scanner of the register;
generating an electronic purchase receipt including the product code and transmitting the generated electronic purchase receipt to a server, when the register is operating in a registration mode; and
generating an electronic return receipt including the product code and transmitting the generated electronic return receipt to the server, when the register is operating in a return mode.

12. The non-transitory computer readable medium according to claim 11, wherein
the register includes an operation key operable by a user, and
the method further comprises setting an operational mode of the register to the return mode in response to a user operation of the operation key.

13. The non-transitory computer readable medium according to claim 11, wherein
the electronic purchase receipt includes a first value indicating that a type thereof is a purchase receipt, and
the electronic return receipt includes a second value indicating that the type thereof is a return receipt.

14. The non-transitory computer readable medium according to claim 13, wherein
the first value and the second value are each a one-digit value.

15. The non-transitory computer readable medium according to claim 11, wherein
the method further comprises storing the product code in a data storage of the register, each time the product code is determined, and
the electronic return receipt is generated so as to include each product code stored in the data storage.
